(19) United States
(12) Patent Application Publication
(10) Pub. No.: US 2012/0315001 A1
(43) Pub. Date: Dec. 13, 2012

(54) FIBER OPTIC CONNECTOR POTTING METHOD

(75) Inventor: Ronald A. Beck, Naples, FL (US)

(73) Assignee: ADC Telecommunications, Inc., Eden Prairie, MN (US)

(21) Appl. No.: 13/492,407

(22) Filed: Jun. 8, 2012

Related U.S. Application Data
(60) Provisional application No. 61/494,751, filed on Jun. 8, 2011.

(51) Int. Cl. G02B 6/36; B32B 37/14

(52) U.S. Cl. 385/78; 156/293

(57) ABSTRACT

A fiber optic connector assembly includes a ferrule and a hub. The ferrule has a distal end and a proximal end, wherein the proximal end of the ferrule is mounted to the hub. The ferrule defines a fiber passage that extends through the ferrule from the proximal end to the distal end. Adhesive is injected through the distal end of the ferrule into the fiber passage. An optical fiber and the fiber optic connector are, then, assembled by inserting the optical fiber into the adhesive filled fiber passage of the fiber optic connector.

### CROSS REFERENCE TO RELATED APPLICATION

The present application claims the benefit of U.S. Provisional Patent Application Ser. No. 61/494,751, which application is hereby incorporated by reference in its entirety.

### TECHNICAL FIELD

The present invention relates to techniques for terminating fiber optic cables with fiber optic connectors. More specifically, the present invention relates to connectorization arrangements and methods that reduce the likelihood for air to enter the adhesive used to pot an optical fiber within a fiber optic connector.

### BACKGROUND

Fiber optic cables may be terminated in two ways—with connectors that can mate two fibers to create a temporary joint and/or connect the fiber to a piece of network equipment or with splices which create a permanent joint between the two fibers. Two basic fiber optic cable designs include loose tube cables and tight buffered cables. Loose tube cables can be designed to endure outside environmental conditions. In a loose tube cable, one or more optical fibers are loosely positioned within a buffer tube contained within an outer jacket of the cable. The buffer tube can be filled with gel to prevent water from migrating along a length of the buffer tube.

Over the years, numerous connector types have been developed. Although the mechanical design varies significantly among different fiber optic connector types, most fiber optic connectors include a fiber ferrule made of ceramic, such as zirconia, or metal, such as stainless steel and a ferrule holder, commonly known as a hub, retaining the ferrule. Other ferrules (e.g., multi-fiber ferrules) can be made of other types of materials such as thermoset materials (e.g., epoxy) or thermoplastic materials (e.g., polyphenylene sulfide (pps)). In the case of single fiber ferrules, a high precision hole is formed (e.g., drilled) in the center of the ferrule, and a stripped bare fiber (the glass core and glass cladding with the coating removed) is inserted through and usually bonded by an adhesive such as epoxy.

Adhesive such as epoxy is used to secure/pot an optical fiber within the ferrule and ferrule hub of a fiber optic connector. Voids or air pockets within the epoxy filling the ferrule hub can leave part of the optical fiber unsupported or unevenly supported thereby increasing the likelihood of optical fiber breakage.

One way of terminating a loose tube fiber optic cable with a fiber optic connector is to inject epoxy into the ferrule and then push the fiber into the ferrule. Alternatively, epoxy is applied to the fiber before the fiber is pushed into the ferrule. If the end of the loose tube spaced from the connector is sealed, the expansion of air inside the tube when curing the epoxy at high temperatures will push air out the end of the loose tube adjacent the connector there introducing bubbles (i.e., voids or air pockets) within the epoxy filling the ferrule hub. Alternatively, if the far end of the loose tube is open, capillary action will draw epoxy into the loose tube from the ferrule hub and leave an insufficient amount of epoxy in the ferrule hub and/or the ferrule.

Attempts have been made to reduce the likelihood of introducing air pockets in the epoxy potting a fiber of a fiber optic connector during assembly of the fiber optic connector. Example attempts are disclosed in U.S. Pat. Nos. 5,381,497; 6,936,122 and 7,708,469, the disclosures of which are hereby incorporated by reference in their entireties. Despite these attempts, improvements are still needed.

### SUMMARY

In general terms, this disclosure is directed to a method and arrangements for reducing air pockets and/or voids in an adhesive filled space of a fiber optic connector.

One aspect relates to a method of potting a fiber optic connector comprising a ferrule assembly including a ferrule and a hub. The ferrule has a distal end and a proximal end, wherein the proximal end of the ferrule is mounted to the hub. The ferrule defines a fiber passage that extends through the ferrule from the proximal end to the distal end. Adhesive is injected through the distal end of the ferrule into the fiber passage. An optical fiber and the fiber optic connector are, then, assembled by inserting the optical fiber into the adhesive filled fiber passage of the fiber optic connector.

Another aspect is a fiber optic connector assembly comprising a ferrule assembly including a ferrule and a hub. The ferrule has a distal end and a proximal end, wherein the proximal end of the ferrule is mounted to the hub. The ferrule defines a fiber passage that extends through the ferrule from the proximal end to the distal end. The fiber passage at the distal end of the ferrule is configured to receive injected adhesive in order to pot an optical fiber provided in the fiber passage.

### BRIEF DESCRIPTION OF THE DRAWINGS

FIG. 1 shows an exemplary fiber optic cable construction.

FIG. 2 is a cross-sectional side view of one embodiment of a fiber optic ferrule and a hub.

FIG. 3 is a flowchart illustrating the procedure performed according to some embodiments of the present invention

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

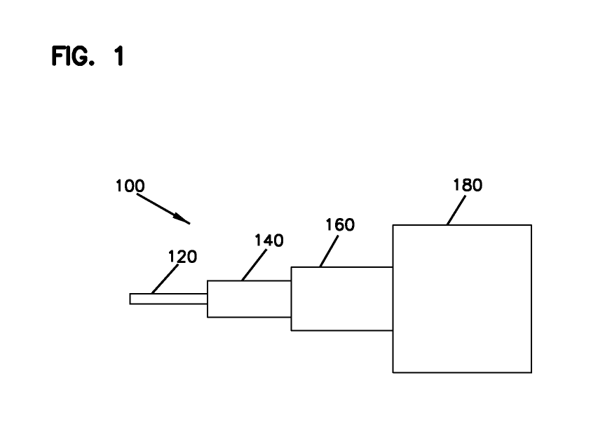

FIG. 1 is an exemplary loose tube fiber optic cable 100 comprising a core 120 having an outer diameter of, for example, ten microns. The core 120 is the thin glass center of the fiber where the light travels. The core 120 is surrounded by a cladding 140 which is an outer optical material (e.g., glass) that reflects the light back into the core. The cladding typically has an outer diameter of about 125 microns. The core 120 and the cladding 140 constitute the inner optical fiber. A coating 160 that surrounds the cladding 140 protects the fiber from damage and moisture. The coating 160 typically has an outer diameter of, for example, about 250 microns. A loose tube covering 180 having an outer diameter of, for example, about 900 microns is applied over the coating 160 and further protects the fiber. This can also be referred to as upjacketing.

There are three main parts to a fiber optic connector: a connector body (i.e. a housing), a ferrule assembly mounted within the connector body and the strain relief boot. The connector body includes a distal end and a proximal end. The distal end can form a plug adapted for insertion in a corresponding fiber optic adapter. The ferrule assembly mounts within the connector body adjacent the distal end. The ferrule assembly includes a ferrule, a ferrule hub supporting a proximal end of the ferrule, and a ferrule spring that biases the ferrule and the hub in a distal direction relative to the connector body. The strain relief boot mounts at the proximal end of the connector body and prevents the optical fiber from bending past a point at which signal degradation occurs (i.e., a minimum bend radius).

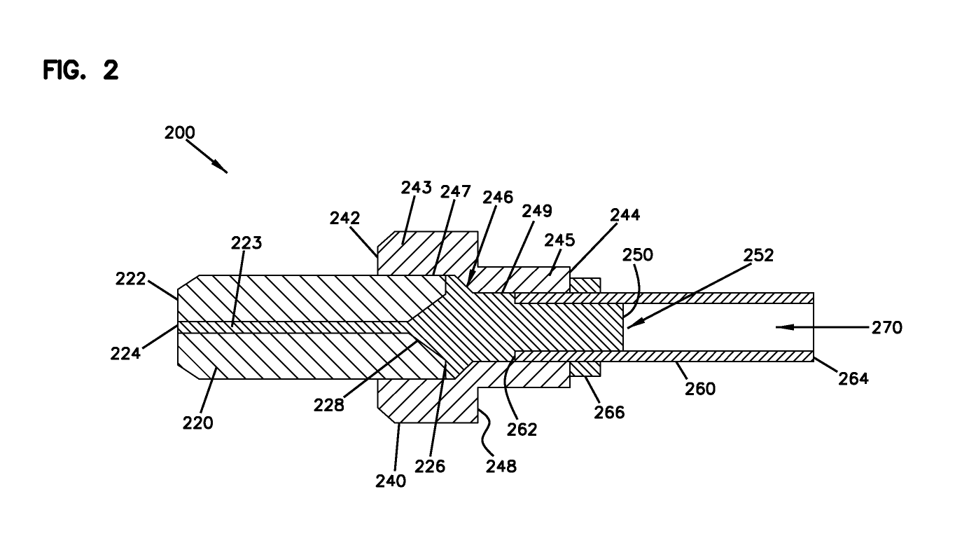

Example connectors are disclosed at U.S. Patent Application Publication No. 2011/002586; and U.S. Pat. Nos. 7,147,385; 5,261,019; and 5,915,056, which are hereby incorporated by reference in their entireties. FIG. 2 shows an exemplary ferrule assembly 200 comprising a fiber optic ferrule 220 mounted to a hub 240. Generally, the ferrule 220 and the hub 240 are secured together by convenient methods including press fit or adhesive mounts. The ferrule 220 and the hub 240 are mounted within a connector body. The connector body can be one of a variety of well known connector types, including SC, FC, ST, LX.5, LC, and others.

The ferrule 220 includes a central passage 223 which is concentric with a central axis of the ferrule 220. The central passage 223 extends from a first distal end 222 of ferrule 220 defining a ferrule tip 224 to a second proximal end 226 and includes a portion 228 which is tapered inward from the second end 226 so as to facilitate insertion of the fiber during installation. The second end 226 of the ferrule 220 is received in a pocket 247 of the hub 240. The central passage 223 has a diameter sized for receiving the inner fiber, i.e. the core 120 and the cladding 140 of the loose tube fiber optic cable 100 as shown in FIG. 1. In one embodiment, this diameter is 125 microns.

The hub 240 includes a first distal end 242 and a second proximal end 244. The hub 240 further includes a first portion 243 and a second portion 245, wherein the diameter of the first portion 243 is larger than the diameter of the second portion 245. An edge 248 defines the transition from the first portion 243 to the second portion 245 on the outer periphery of the hub 240. The first portion 243 of the hub 240 include the pocket 247 adapted to receive the second end 226 of the ferrule 220. As discussed above, assembling of the connector body 200 with the fiber may form voids or air pockets leaving parts of the fiber unsupported inside the connector body. According to some embodiments of the invention, the hub 240 is provided with an angled section 246 on the inner periphery that facilitates the escape of air in this area during the epoxy potting. The angled section 246 of the hub 240 is located in the vicinity of the transition between the first portion 243 and the second portion 245 of the hub 240.

Epoxy 250 or other adhesive is used within the central passage 223 to adhesively hold the cable 100 to the ferrule 220. One example epoxy that may be used is F123 from Tra-con, Inc. of Bedford, Mass. According to one embodiment of the invention, the epoxy 250 is injected into the tip 224 of the ferrule 220 when the connector body 200 is in an essentially vertical position taking advantage of the force of gravity. Optionally, the connector body 200 is rotated during the fill so that centrifugal forces assist in the fill operation in order to displace air inside the connector body 200. In some embodiments, a precisely-metered epoxy dispenser is used in the fill operation to inject a desired amount of epoxy within the ferrule 220. The desired amount of epoxy depends on the amount of anticipated epoxy displacement when the fiber is inserted into the connector body.

According to one embodiment of the invention, a tube 260 is inserted into a pocket 249 formed in the second portion 245 of the hub 240 in order to provide a fitting for vacuum force and regulate the amount of epoxy remaining within the connector body. The tube 260 includes a first distal end 262 which is inserted into the pocket 249 of the hub 240 and a second proximal open end 264. The tube 260 may be a transparent disposable plastic tube which provides a visual indication of the amount of epoxy filled, denoted 252 in FIG. 2, within the connector body. The tube 260 may be provided with a flange 266 to set the insertion depth of the tube 260 into the hub 240. Thus, vacuum, denoted with an arrow 270, is applied to the open end 264 of the tube 260 while epoxy 250 is injected into the ferrule capillary until it is visible within the tube 260. When the desired amount 252 of epoxy 250 has been injected into the connector body 200, the tube 260 is removed or discarded.

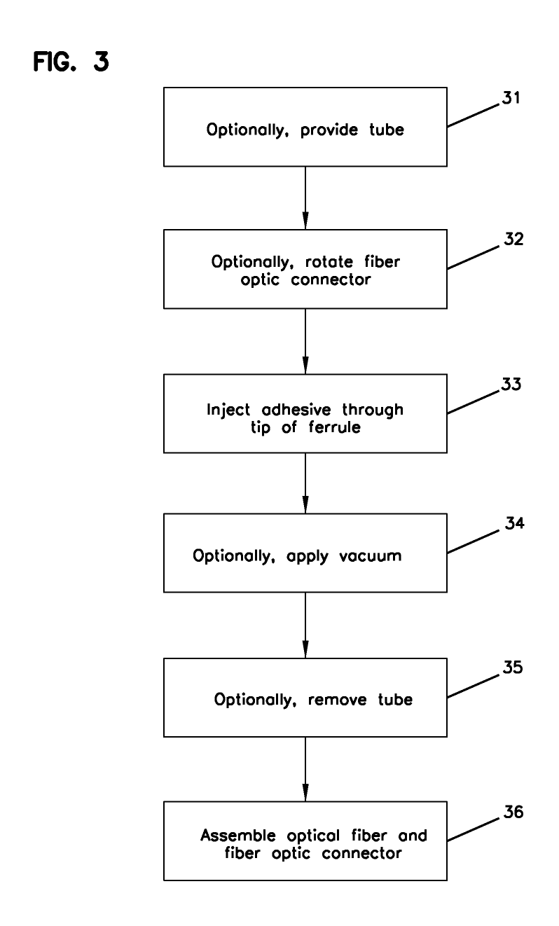

According to some embodiments, a procedure of potting a fiber optic connector including a ferrule and a ferrule holder adapted for receiving an optical fiber in a passage extending therethrough, as shown in FIG. 3, is as follows:

injecting adhesive (step 33) through a tip end of the ferrule into the passage extending through the fiber optic connector; and

assembling the optical fiber and the fiber optic connector by inserting the optical fiber into the adhesive filled passage of the fiber optic connector (step 36).

According to some embodiments, the fiber optic connector is rotated during the injection of adhesive into the fiber optic connector passage (step 32).

According to some embodiments, the procedure further comprises the steps of: providing a first end of a tube in one end of the ferrule holder (step 31); applying a vacuum force (step 34) at a second end of the tube during the injection of adhesive into the fiber optic connector passage; and removing the tube when a desired amount of adhesive has been injected (step 35).

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method of potting a fiber optic connector including a ferrule and a hub, the ferrule having a distal end and a proximal end, the proximal end of the ferrule being mounted to the hub, the ferrule defining a fiber passage that extends through the ferrule from the proximal end to the distal end, the method comprising the steps of:
injecting adhesive through the distal end of the ferrule into the fiber passage; and
assembling an optical fiber and the fiber optic connector by inserting the optical fiber into the adhesive filled fiber passage of the fiber optic connector.

2. A method according to claim 1, further comprising the step of rotating the fiber optic connector during the injection of adhesive into the fiber optic connector passage.

3. A method according to claim 1, further comprising the steps of:
providing a first end of a tube in a proximal end of the hub;
applying a vacuum force at a second end of the tube during the injection of adhesive into the fiber optic connector passage; and
removing the tube when a desired amount of adhesive has been injected.

4. A fiber optic connector assembly, comprising:
a ferrule assembly including a ferrule and a hub, the ferrule having a distal end and a proximal end, the proximal end of the ferrule being mounted to the hub, the ferrule defining a fiber passage that extends through the ferrule from the proximal end to the distal end, wherein the fiber passage at the distal end of the ferrule is configured to receive injected adhesive in order to pot an optical fiber provided in the fiber passage.

5. A fiber optic connector assembly according to claim 4, further comprising a removable tube provided in a proximal end of the hub and adapted to provide a fitting for a vacuum force.

6. A fiber optic connector assembly according to claim 5, wherein the tube is made from a transparent plastic material.

7. A fiber optic connector assembly according to claim 5, wherein the tube is provided with a flange to set an insertion depth of the tube into the hub.

8. A fiber optic connector assembly according to claim 4, wherein an inner periphery of the hub is provided with an angled section.
